(19) United States
(12) Patent Application Publication
(10) Pub. No.: US 2025/0293858 A1
(43) Pub. Date: Sep. 18, 2025

(54) SYSTEMS AND METHODS FOR SECURELY MANAGING ACCESS TO VEHICLE DATA

(71) Applicant: TOYOTA JIDOSHA KABUSHIKI KAISHA, Toyota-shi (JP)

(72) Inventor: Caleb MCGARY, Tokyo (JP)

(73) Assignee: TOYOTA JIDOSHA KABUSHIKI KAISHA, Toyota-shi (JP)

(21) Appl. No.: 18/606,837

(22) Filed: Mar. 15, 2024

(51) Int. Cl. H04L 9/08; H04L 9/00

(52) U.S. Cl. CPC H04L 9/0822; H04L 9/0825; H04L 9/0866; H04L 9/0891; H04L 9/50

(57) ABSTRACT

Provided are a method, system, and device for optimizing performance of a vehicle. The method may include, receiving vehicle condition data prior to operating the vehicle; generating, based on the vehicle condition data, input data for a machine learning (ML) model, wherein the ML model is configured to output at least one of predicted vehicle performance and vehicle parameters based on the vehicle condition data; suggesting, by the ML model, optimized vehicle parameters based on the input data; and sending, based on the optimized vehicle parameters, instructions to tune the vehicle.

Systems and methods consistent with example embodiments of the present disclosure relate to managing access to vehicle data using encryption and blockchain-related techniques.

### BACKGROUND

Vehicles may collect a variety of data (e.g., telemetry) during operation, which may include personal data, that is, data which impacts the privacy of a user.

In the related art, an access control list may be used in order to allow specific operators to have access to user data. This access control list may be static. As an example in the related art, when the driver of the vehicle changes, a notification may be sent (e.g., to a cloud network), and a new access control list may be generated then sent to the vehicle (e.g., via an over-the-air (OTA) update). The new access control list may govern access until another change occurs, or a new access control list is received.

Applications which are external to the vehicle may intend to receive private data from the vehicle (for example, by a vehicle mechanic using an application for maintenance). In the related art, the request may be checked against the access control list stored in the vehicle. In the case the application is a new application, the request may firstly be sent to the cloud, where it may be checked against user permissions which are registered, and if the access control list on the vehicle needs to be updated, an updated access control list may be generated at the cloud and sent to the vehicle.

The method in the related art may require large amounts of storage space, since user permissions may need to be stored in a large cloud database. Such a cloud database does not scale. Also, since new access control lists need to be generated for each change, granting or revoking user permissions may be cumbersome and not agile. Further, the related art may generate encryption keys in the cloud (for encrypting the user data), and such encryption keys may need to be stored in an expensive cloud key management system.

Accordingly, there is a need for a more agile and efficient method for securely managing access to data stored in a vehicle.

### SUMMARY

According to one or more example embodiments, apparatuses and methods are provided controlling access to data collected by a vehicle. In particular, the method may include receiving, by the vehicle, a request from an application for access to the data, wherein the data is encrypted with a user key; authenticating the request to determine whether the request is allowed; based on determining that the request is allowed, wrapping the user key with a wrapping key, wherein the wrapping key has a validity period; and sending the wrapped user key and the data to the application.

According to embodiments, the user key may be generated by the vehicle based on a vehicle root of trust key stored in a vehicle and a user key stored in a user mobile device.

According to embodiments, authenticating the request may include storing a result of whether the request is allowed in a blockchain ledger. Authenticating the request may include prompting a user on a user mobile device whether or not to allow the request. The blockchain ledger may be configured to store the revocation of a wrapping key based on the validity period or revocation from a user on the user mobile device.

According to embodiments, the method may include decrypting the wrapped user key with the wrapping key; and decrypting the data with the user key.

According to embodiments, wrapping the user key may include: encrypting the wrapping key with a private key of the user; sending the wrapping key encrypted with the private key to the vehicle; and decrypting the wrapping key with a public key of the user by the vehicle, wherein wrapping the user key is performed by the vehicle.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a block diagram showing a scenario for accessing data from a vehicle according to one or more example embodiments;

FIG. 3 is a block diagram showing a scenario for generating a user key by a vehicle according to one more embodiments;

FIG. 4 is a flowchart diagram showing a method for securely accessing data from a vehicle according to one or more embodiments; and

FIG. 5 is a flowchart diagram showing a method for transmitting a wrapping key to the vehicle according to one or more embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

The term “software part”, as used herein refers to an individual component or unit of software which may implement one or more feature(s). These software parts may be dependent on other software parts. A plurality of software parts which have the same software part type may also be provided. Specifically, a software part type may indicate what the software part is intended for (e.g., SDK, integration, for system testing, etc.). Each of these software part types may have standards (for example, ISO standards) which need to be passed in order for the software part to pass a specific developmental stage (for example, a coverage stage in which the user is still intending to collect and evaluate code coverage metrics only). These standards may be evaluated in terms of metrics. According to some embodiments, each software part may have an identifier including, but not limited to, a version number and a feature name.

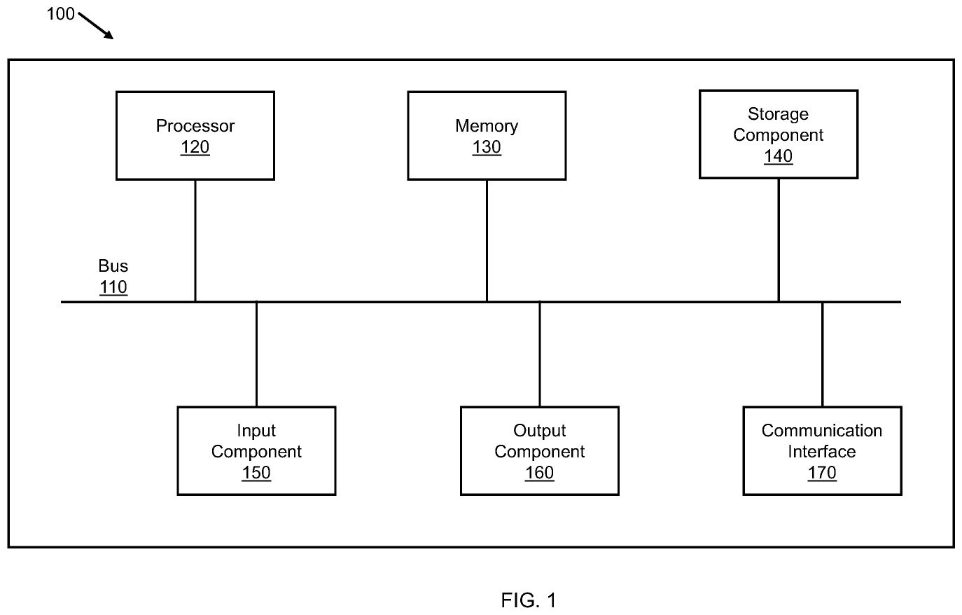

FIG. 1 is a diagram of example components of a device 100. As shown in FIG. 1 device 100 may include a bus 110, a processor 120, a memory 130, a storage component 140, an input component 150, an output component 160, and a communication interface 170.

Bus 110 includes a component that permits communication among the components of device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 120.

Storage component 140 stores information and/or software related to the operation and use of device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from device 100 (e.g., a display, a speaker, and/or one or more light-emitting diodes (LEDs)).

The communication interface 170 includes a transceiver-like component (e.g., a transceiver and/or a separate receiver and transmitter) that enables device 100 to communicate with other devices, such as via a wired connection, a wireless connection, or a combination of wired and wireless connections. The communication interface 170 may permit the device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The device 100 may perform one or more example processes described herein. According to one or more example embodiments, the device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the device 100 may include additional components, fewer components, different components, or differently arranged components than those shown in FIG. 1. Additionally, or alternatively, a set of components (e.g., one or more components) of the device 100 may perform one or more functions described as being performed by another set of components of the device 100.

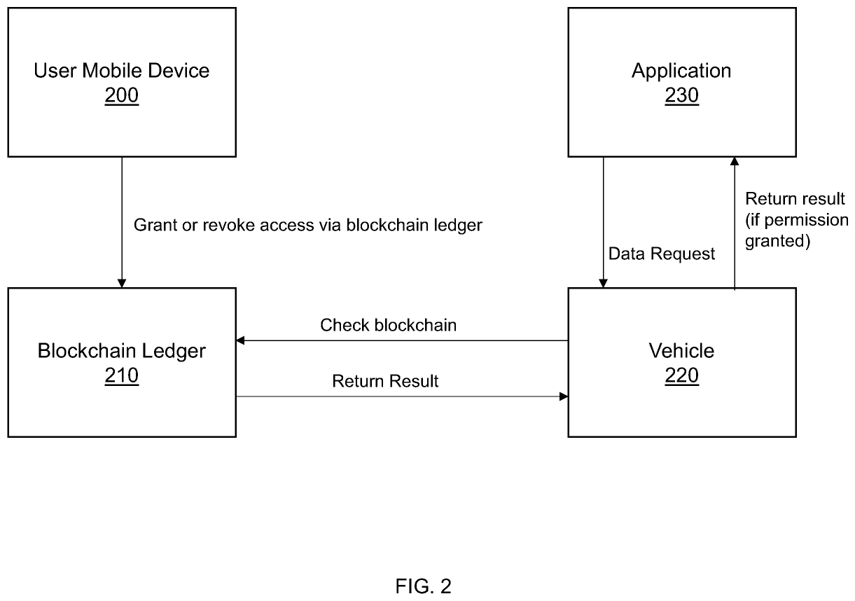

FIG. 2 is a block diagram showing a scenario for accessing data from a vehicle according to one or more example embodiments.

User mobile device 200, blockchain ledger 210, vehicle 220, and application 230 may be provided.

User mobile device 200 may be a device such as a smartphone, or a device similar to device 100 (as described above). A user may interact with user mobile device 200, for example, using a graphical user interface. User mobile device 200 may be used to grant or revoke access to applications (such as application 230) for data which was collected by vehicle 220 (and may include privacy sensitive data), and such data is encrypted with a user key which is unique to the user. According to embodiments, when access is granted to an application, a wrapping key may be generated by user mobile device 200, and used to wrap the user key. The wrapping key may have a validity period (such as an expiration date), such that the access which is granted to the application is time-based. Granting or revoking access may be performed by recording a transaction onto blockchain ledger 210.

Blockchain ledger 210 may be a distributed ledger which is implemented using a blockchain, according to embodiments. Transactions which are performed by user mobile device 200 may be recorded thereon. Blockchain ledger 210 may be associated permanently with a specific user.

Vehicle 220 may include an Electronic Control Unit (ECU) which is responsible for communicating with blockchain ledger 210, as well as application 230. Vehicle 220 may perform an operation to check whether blockchain ledger 210 has a transaction which indicates granted access to application 230 for access data collected by the vehicle. The result from checking may be returned to vehicle 220.

Application 230 may be a user application which is external to vehicle 220 (for example, an application used by a vehicle mechanic in order to determine the best maintenance of the user's vehicle. The application may send a request to access data collected by vehicle 220, and based on access being granted, data (which will be encrypted with a user key) may be returned to application 230, as well as a user key which has been wrapped with the wrapping key generated by user mobile device 200.

As an example, a mechanic may request telemetry access (via application 230) which was collected on vehicle 220 in order to service vehicle 220. The request may be routed from vehicle 220 to user's mobile device 200 to either grant or deny access. The user may grant consent on user's mobile device 200, a transaction may be recorded onto blockchain ledger 210 to indicate permission was granted, and a wrapping key may be generated having a validity period of 12 hours and sent to the vehicle. According to embodiments, the wrapping key may be encrypted using the user's private key and sent to vehicle 220, and once received by vehicle 220, the wrapping key may be decrypted using the user's public key. The wrapping key may be used to wrap the user key which was used to encrypt the data collected by the vehicle. Both the wrapped user key and the encrypted data may be sent to the mechanic's application (application 230), and the mechanic will be able to use the wrapping key to decrypt the user key from the wrapped user key, and thereafter use the user key to decrypt the collected data. Once the validity period of 12 hours has passed, the wrapping key will no longer be valid, and the user key can no longer be decrypted using the wrapping key.

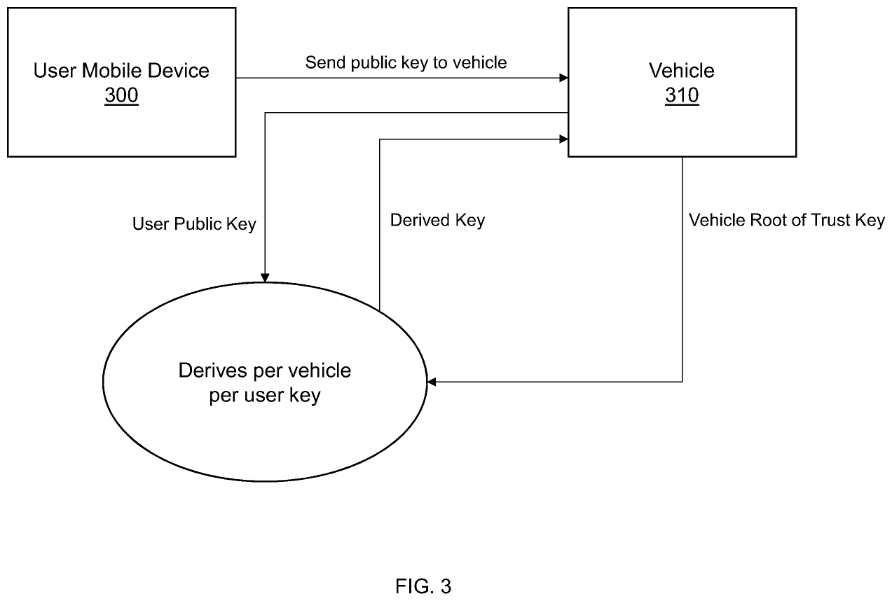

FIG. 3 is a block diagram showing a scenario for generating a user key by a vehicle according to one more embodiments.

User mobile device 300 may send its public key to vehicle 310. Vehicle 310 may use both the user public key (which is unique to each user) and a vehicle root of trust key (which is unique to each vehicle) in order to derive a user key (e.g., using an algorithm such as Elliptic-Curve Diffie-Heffman). Accordingly, the derived user key will be on a per user, per vehicle basis, and will be unique.

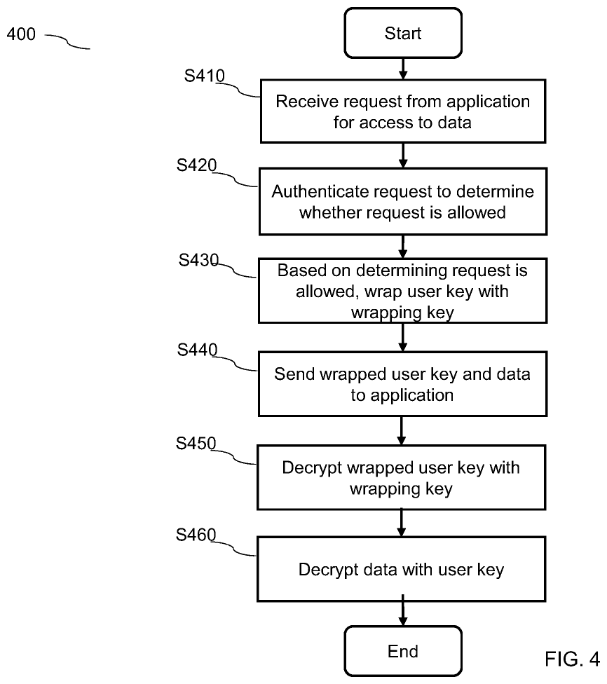

FIG. 4 is a flowchart diagram showing a method 400 for securely accessing data from a vehicle according to one or more embodiments.

At operation S410, a request for accessing data may be received from an application (i.e. application 230). The data may be collected by a vehicle (i.e., vehicle 220), and encrypted using a user key which may be unique to each user. Particularly, the user key may generated by the vehicle based on a vehicle root of trust key stored in a vehicle and a user key stored in a user mobile device (i.e., user mobile device 200).

At operation S420, the request received in operation S410 may be authenticated in order to determine whether the request is allowed or not. According to embodiments, whether or not the request is allowed may be stored in a blockchain ledger (i.e., blockchain ledger 210). According to embodiments, the user may be prompted, using a user mobile device whether or not to allow the request.

At operation S430, if it was determined the request is allowed, the user key is wrapped with a wrapping key to obtain a wrapped user key. According to some embodiments the blockchain ledger may be configured to store the revocation of a wrapping key based on the validity period or revocation from a user on the user mobile device.

At operation S440, the wrapped user key and data is sent to the application.

At operation S450, the wrapped user key may be decrypted using the wrapping key, in order to obtain the user key. This may be performed at the application.

At operation S460, the data may be decrypted using the user key. Accordingly, the requested data may be decoded by the application.

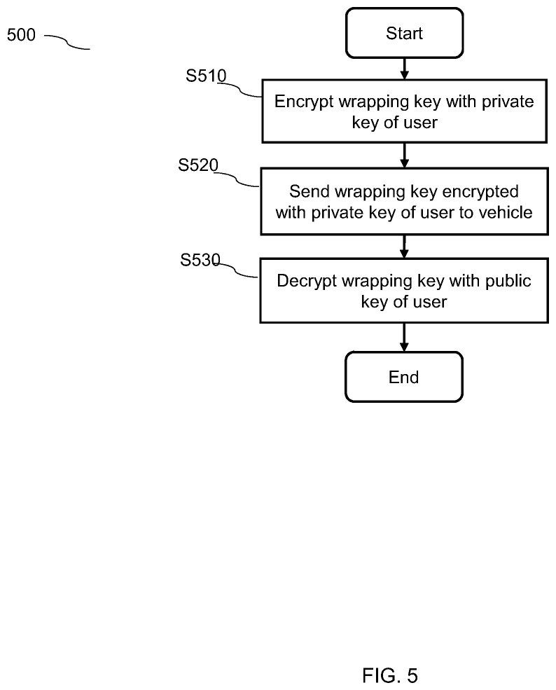

FIG. 5 is a flowchart diagram showing a method 500 for transmitting a wrapping key to the vehicle according to one or more embodiments. Method 500 may be part of operation S430, according to embodiments.

At operation S510, the wrapping key, which was generated by the user (via a user mobile device), may be encrypted using the private key of the user. In other words, the wrapping key may be digitally signed by the user in order to prove its authenticity.

At operation S520 the wrapping key which was encrypted (i.e., digitally signed) using the private key of the user in operation S510 may be sent to the vehicle.

At operation S530, the encrypted wrapping key obtained in operation S520 may be decrypted using the public key of the user (by the vehicle). The public key of the user may have been transmitted to the vehicle in advance. This is in order for the vehicle to ascertain that the wrapping key was sent from the user, and not by someone else (such as a malicious 3rd party trying to pretend to be the user).

Based on the above, time-based access to data collected by a vehicle may be securely accessed without requiring use of an Access Control List. In addition, since a blockchain ledger is used, the user may keep a record of granting/revoking access. Further, there is no need for any external key generation (such as in a backend key management system in a cloud), since keys are generated by a user's mobile device or in the vehicle. Accordingly, the cloud does not need store any keys. Accordingly, a more secure and agile method of controlling access to data collected by the vehicle may be achieved.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code—it being understood that software and hardware may be designed to implement the systems and/or methods based on the description herein.

What is claimed is:

1. A method for controlling access to data collected by a vehicle, the method comprising:
receiving, by the vehicle, a request from an application for access to the data, wherein the data is encrypted with a user key;
authenticating the request to determine whether the request is allowed;
based on determining that the request is allowed, wrapping the user key with a wrapping key, wherein the wrapping key has a validity period; and
sending the wrapped user key and the data to the application.

2. The method of claim 1, wherein the user key is generated by the vehicle based on a vehicle root of trust key stored in a vehicle and a user key stored in a user mobile device.

3. The method of claim 1, wherein authenticating the request comprises storing a result of whether the request is allowed in a blockchain ledger.

4. The method of claim 3, wherein authenticating the request comprises prompting a user on a user mobile device whether or not to allow the request.

5. The method of claim 4, wherein the blockchain ledger is configured to store the revocation of a wrapping key based on the validity period or revocation from a user on the user mobile device.

6. The method of claim 1, further comprising:
decrypting the wrapped user key with the wrapping key; and
decrypting the data with the user key.

7. The method of claim 1, wherein wrapping the user key comprises:
encrypting the wrapping key with a private key of the user;
sending the wrapping key encrypted with the private key to the vehicle; and
decrypting the wrapping key with a public key of the user by the vehicle, wherein wrapping the user key is performed by the vehicle.

8. An apparatus for controlling access to data collected by a vehicle, the apparatus comprising:
at least one memory storing computer-executable instructions; and
at least one processor configured to execute the computer-executable instructions to:
receive, by the vehicle, a request from an application for access to the data, wherein the data is encrypted with a user key;
authenticate the request to determine whether the request is allowed;
based on determining that the request is allowed, wrap the user key with a wrapping key, wherein the wrapping key has a validity period; and
send the wrapped user key and the data to the application.

9. The apparatus of claim 8, wherein the user key is generated by the vehicle based on a vehicle root of trust key stored in a vehicle and a user key stored in a user mobile device.

10. The apparatus of claim 8, wherein the at least one processor is configured to authenticate the request by storing a result of whether the request is allowed in a blockchain ledger.

11. The apparatus of claim 10, wherein the at least one processor is configured to authenticate the request by prompting a user on a user mobile device whether or not to allow the request.

12. The apparatus of claim 11, wherein the blockchain ledger is configured to store the revocation of a wrapping key based on the validity period or revocation from a user on the user mobile device.

13. The apparatus of claim 8, wherein the at least one processor is further configured to execute the computer-executable instructions to:
decrypt the wrapped user key with the wrapping key; and
decrypt the data with the user key.

14. The apparatus of claim 8, wherein the at least one processor is configured to wrap the user key by:
encrypting the wrapping key with a private key of the user;
sending the wrapping key encrypted with the private key to the vehicle; and
decrypting the wrapping key with a public key of the user by the vehicle, wherein wrapping the user key is performed by the vehicle.

15. A non-transitory computer-readable recording medium having recorded thereon instructions to perform a method comprising:
receiving, by the vehicle, a request from an application for access to the data, wherein the data is encrypted with a user key;
authenticating the request to determine whether the request is allowed;
based on determining that the request is allowed, wrapping the user key with a wrapping key, wherein the wrapping key has a validity period; and
sending the wrapped user key and the data to the application.

16. The non-transitory computer-readable recording medium of claim 15, wherein the user key is generated by the vehicle based on a vehicle root of trust key stored in a vehicle and a user key stored in a user mobile device.

17. The non-transitory computer-readable recording medium of claim 15, wherein authenticating the request comprises storing a result of whether the request is allowed in a blockchain ledger.

18. The non-transitory computer-readable recording medium of claim 17, wherein authenticating the request comprises prompting a user on a user mobile device whether or not to allow the request.

19. The non-transitory computer-readable recording medium of claim 18, wherein the blockchain ledger is configured to store the revocation of a wrapping key based on the validity period or revocation from a user on the user mobile device.

20. The non-transitory computer-readable recording medium of claim 15, the method further comprising:
decrypting the wrapped user key with the wrapping key; and
decrypting the data with the user key.
